(19) United States
(12) Patent Application Publication
(10) Pub. No.: US 2015/0371223 A1
(43) Pub. Date: Dec. 24, 2015

(54) METHOD AND SYSTEM FOR IDENTIFYING AND PROCESSING TEXT OPERATION INSTRUCTION, AND SERVER

(71) Applicant: Tencent Technology (Shenzhen) Company Limited, Shenzhen (CN)

(72) Inventors: Xiaoya LI, Shenzhen (CN); Junyu LIU, Shenzhen (CN); Ming ZENG, Shenzhen (CN)

(21) Appl. No.: 14/842,380

(22) Filed: Sep. 1, 2015

Related U.S. Application Data
(63) Continuation of application No. PCT/CN2013/090194, filed on Dec. 23, 2013.

(30) Foreign Application Priority Data
Apr. 26, 2013 (CN) 201310149383.4

(51) Int. Cl. G06Q 20/38; H04L 12/58; G06Q 20/32; G06F 17/27; H04L 29/08; H04L 29/06

(52) U.S. Cl. CPC G06Q 20/38; H04L 67/16; H04L 67/42; G06Q 20/3255; G06F 17/2785; H04L 51/046; H04L 67/10

(57) ABSTRACT

A method and system for identifying and processing text operation instruction, and a server are provided. The method includes a communication terminal performing: presenting a communication session window between a user and a network transaction system; receiving text information input by the user in the communication session window, and performing text semantic analysis on the text information to determine an operation type and an operation instruction field; sending the determined operation type and operation instruction field to the network transaction system; and receiving response information returned by the network transaction system, and outputting the response information to the communication session window.

### RELATED APPLICATION

This application is a continuation of International Application No. PCT/CN2013/090194, filed on Dec. 23, 2013, which claims priority to Chinese Patent Application No. 201310149383.4, titled “METHOD AND SYSTEM FOR IDENTIFYING AND PROCESSING TEXT OPERATION INSTRUCTIONIN NETWORK TRANSACTION SYSTEM” and filed with the Chinese Patent Office on Apr. 26, 2013, both of which are hereby incorporated by reference in their entireties.

### FIELD OF THE TECHNOLOGY

This application relates to the technical field of human-computer interaction in network transaction system, and in particular, to a method and system for identifying and processing text operation instruction, a server and a storage medium.

### BACKGROUND OF THE DISCLOSURE

At present, with the popularization of network, network transaction system becomes increasingly popular. The network transaction system refers to a data processing system that implements information transmission and financial settlement for electronic transactions through the Internet. By using the network transaction system, an indoor user can purchase products and services on line through network.

At present, various Internet-based communication tools also become increasingly popular, for example, instant communication tools, and social communication tools, such as microblog, WeChat and momo, all have a large quantity of users.

Users often perform crossover operations between Internet-based communication tools and the network transaction system. A seller in the network transaction system also has an account of the communication tool, and may perform information communication with a buyer by establishing a communication session window (such as a chat window) in the communication tool with the account. If there is a demand for transaction, the account of the seller pushes a link, in the network transaction system, of a product or service in selling to the session window that is established with the buyer. Once the buyer clicks the link, a new program or page is opened to display the product or service in selling, and then the buyer performs a human-computer interaction with the new program or page to conduct the network transaction.

However, in the existing technical solution, if the user has the demand for transaction when uses the communication tool, a new program or page needs to be opened for the network transaction. During this process, the user not only needs to switch between the communication tool and the new program or page, but also needs to perform human-computer interaction with the new program or page. Therefore, operation is complex, efficiency is low, and consumed time is long. Besides, because terminal device resources (resources such as memory and CPU) need to be invoked to open the new program or page, consumption of the terminal resources is caused, and the operation efficiency is further affected. This defect is prominent especially when a portable intelligent terminal having limited processing capability is used to process a network transaction.

### SUMMARY

In view of this, an embodiment of the present invention provides a method for identifying and processing text operation instruction, to improve convenience and operation efficiency of a network transaction, and to reduce consumption of terminal resources.

An embodiment of the present invention further provides a system for identifying and processing text operation instruction, to improve convenience and operation efficiency of a network transaction, and to reduce consumption of terminal resources.

An embodiment of the present invention further provides a server, to improve convenience and operation efficiency of a network transaction, and to reduce consumption of terminal resources.

An embodiment of the present invention further provides a storage medium, to improve convenience and operation efficiency of a network transaction, and to reduce consumption of terminal resources.

The technical solutions of the present disclosure are implemented as follows:

A method for identifying and processing text operation instruction on a communication terminal includes the communication terminal performing:

presenting a communication session window between a user and a network transaction system;

receiving text information input by the user in the communication session window, and performing text semantic analysis on the text information to determine an operation type and an operation instruction field;

sending the determined operation type and operation instruction field to the network transaction system; and

receiving response information returned by the network transaction system, and outputting the response information to the communication session window.

A storage medium stores a computer program, the computer program being executed by a proessor which causes the communication terminal to perform the foregoing method.

A system for identifying and processing text operation instruction includes:

a session module, configured to present a communication session window between a user and a network transaction system;

an instruction analysis module, configured to receive text information input by the user in the communication session window, and perform text semantic analysis on the text information to determine an operation type and an operation instruction field;

an instruction sending module, configured to send the operation type and the operation instruction field that are determined by the instruction analysis module to the network transaction system; and

a response module, configured to receive response information returned by the network transaction system, and output the response information to the communication session window.

A server includes:

an instruction analysis module, configured to receive text information, and perform text semantic analysis on the text information to determine an operation type and an operation instruction field;

an instruction sending module, configured to send the operation type and the operation instruction field that are determined by the instruction analysis module to a network transaction system; and

a response module, configured to receive response information returned by the network transaction system, and output the response information to a sender of the text information.

### BRIEF DESCRIPTION OF THE DRAWINGS

The following accompanying drawings are merely some embodiments of the technical solutions of the present disclosure, and the present disclosure is not limited to features shown in the figures. Similar numerals in the following accompanying drawings indicate similar elements:

FIG. 1 is a flowchart of a method for identifying and processing text operation instruction according to an embodiment of the present disclosure;

FIG. 2 is a schematic composition diagram of a system for identifying and processing text operation instruction according to the present disclosure;

FIG. 3 is a specific schematic composition diagram of an instruction analysis module according to an embodiment of the present invention; and

FIG. 4 is a schematic diagram of signal interaction and composition of a server and a front-end device according to the present disclosure.

### DESCRIPTION OF EMBODIMENTS

For brief and intuitive description, the following describes the solutions of the present invention disclosure by describing several typical embodiments. A large amount of details in the embodiments are merely used to help understand the solutions of the present disclosure. However, obviously, implementation of the technical solutions of the present disclosure is limited to these details. To avoid making the solutions of the present invention disclosure obscure, some implementation manners are not described in detail, but only a framework is given. In the following descriptions, “include” refers to “include but not limited to”, and “according to . . . ” refers to “at least according to . . . , but not limited to according to . . . ” Due to the language convention, when the number of elements is not specified in the following descriptions, it means that there may be one or more elements, or it may be understood that there is at least one element.

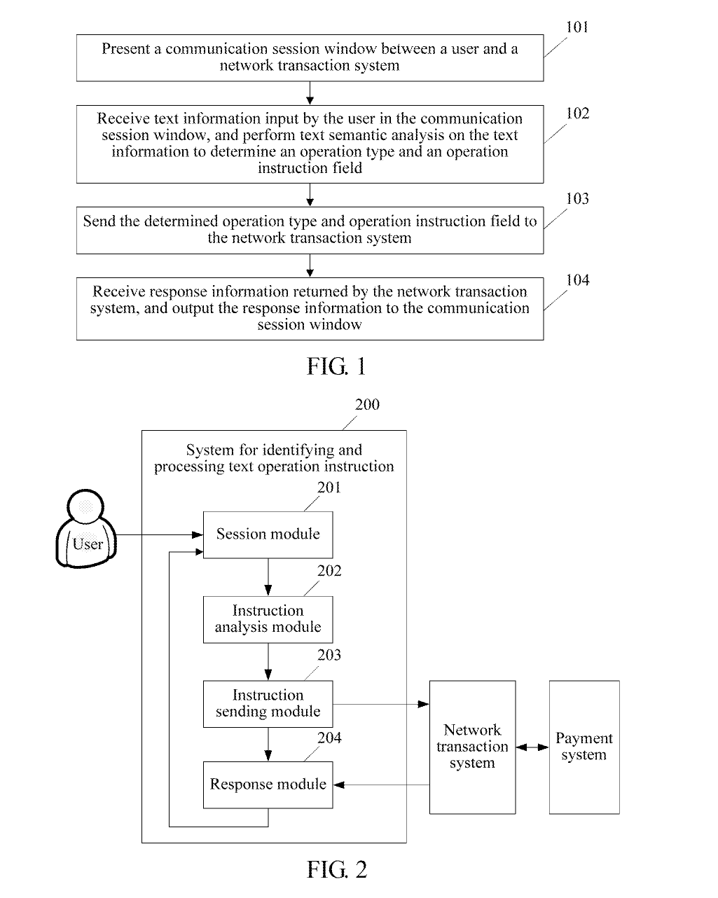

FIG. 1 is a flowchart of an embodiment of a method for identifying and processing text operation instruction according to the present disclosure. Referring to FIG. 1, the method for identifying and processing text operation instruction of the present disclosure specifically includes the following steps.

In Step 101, a communication session window between a user and a network transaction system is presented.

In step 101, presenting a communication session window between a user and a network transaction system includes presenting, in a specified communication tool, a communication session window between a user account and a specified transaction target account of the network transaction system.

The specified communication tool may be, for example, an instant communication tool program or social communication tool installed on an intelligent terminal, such as WeChat and microblog. The intelligent terminal refers to an intelligent terminal having a function of data calculation and processing, which includes, but not limited to, computer, smartphone, palmtop computer, tablet computer, and smart television (smart TV). The intelligent terminals all have an operating system installed, which includes, but not limited to, Windows operating system, LINUX operating system, Android operating system, Symbian operating system, Windows mobile operating system, and Apple iPhone OS operating system.

Some specific types of intelligent terminals and specific operating system types are listed in detail above, but a person skilled in the art can understand that the implementation manners of the present disclosure are not limited to the types listed above, but also applicable to any other intelligent terminal types and operating system types.

The communication session window is a session window of the communication tool, for example, a communication session window of instant communication software, or a communication session window of social communication software. Specifically, the communication session window is, for example, a chat window of instant communication software, or a public window of WeChat software. In these communication tools, a user needs to open the communication session window when communicating with a friend, and uses the communication session window to perform text, voice, and even video communication. In the present disclosure, the window of a communication session with the transaction system refers to a communication session window in which the user communicates and interacts with a specified transaction target account of the network transaction system, and the communication session window may include functions of an existing communication session window. For example, in an instant communication tool program, the network transaction system may specify one or more transaction target accounts. The transaction target accounts are registered on the communication tool, and the transaction target accounts are seller accounts of the network transaction system. There is a communication interface between the communication tool program and the network transaction system, which is used to transmit interaction information described in the present disclosure. When the user uses the communication tool, the user may select one of the transaction target accounts, and submits a request instruction for establishing a communication session window, for example, a chat window, with the transaction target account. In the method of the present disclosure, after such a request instruction is received, a communication session window between the user account and the specified transaction target account of the network transaction system is presented. The user account is also a legitimate account in the network transaction system, and the user account has sufficient balance in the network transaction system for a subsequent payment.

In Step 102, text information input by the user in the communication session window is received, and text semantic analysis is performed on the text information to determine an operation type and an operation instruction field.

In the present disclosure, it is needed to pre-store text features corresponding to various operation types of a network transaction, operation instruction fields included by the operation types, and text features of all the operation instruction fields.

For example, the operation type may include: a recharge operation type, a game card operation type, a mobile phone sale operation type, and the like.

For example, for the recharge operation type, a corresponding text feature is text such as “recharge” included in text information. Operation instruction fields included by the recharge operation type include: a phone number field and a money amount field. A text feature corresponding to the phone number field is: a numerical string that has a specified quantity of digits (for example, 11 digits) and starts with a common mobile phone number such as 131, 132, . . . , 136, . . . , 139, or 186, a numerical string that has a specified quantity of digits (11 digits or 12 digits) and starts with a common area code of a fixed-line phone number or the like, a numerical string that has a specified quantity of digits (for example, 8 digits), a numerical string that follows the expression such as “phone” and “contact information” in the foregoing descriptions, and the like. A text feature corresponding to the money amount field is: a numerical string that ends with a monetary unit such as “Yuan”, and the like.

Step 102 specifically includes the following steps A-D.

Step A: Receiving the text information input by the user in the communication session window. For example, the user inputs text information “I want to recharge the number 13811112222 for 100 Yuan” in the communication session window.

Step B: Checking whether the text information includes a text feature corresponding to a pre-stored operation type, and if yes, determine the pre-stored operation type as the operation type corresponding to the text feature.

For example, for the text information “I want to recharge the number 13811112222 for 100 Yuan” in the foregoing example, because the text information includes a text feature of “recharge”, it is determined that the operation type is an operation type corresponding to the text feature, that is, the recharge operation type.

In Step C, each operation instruction field included by the pre-stored operation type and a text feature of each operation instruction field are read.

For example, for the determined recharge operation type, all operation instruction fields of the operation type, i.e., the phone number field and the money amount field, and text features corresponding to the two operation instruction fields are read.

In Step D: It is checked, according to the text features of the operation instruction fields, whether the text information includes text having the text features, and if yes, determine the text as the operation instruction fields.

For example, the foregoing text information includes a numerical string “13811112222”, the numerical string has the text feature of the phone number field, i.e., the numerical string starts with 138 and has a specified quantity of digits namely 11 digits, and therefore, the numerical string “13811112222” is determined as the phone number field. In addition, the foregoing text infoiination also includes text “100 Yuan”, i.e., the text information has the text feature of the money amount field, and therefore. “100” is determined as the money amount field.

In Step 103, the determined operation type and operation instruction field are sent to the network transaction system.

For example, herein, the operation type sent to the network transaction system is the recharge operation type, and the operation instruction fields included in the recharge operation type are: a phone number field “13811112222” and a money amount field “100”.

In step 103, the information is sent by the user account, and is received by the transaction target account. Because the transaction target account is also an account of the network transaction system, and there is a communication interface between the network transaction system and the communication tool, the information sent from the user account to the transaction target account may be transmitted to the network transaction system. The operation type and the operation instruction field may be sent to the network transaction system in a standard format that is agreed with the network transaction system, so as to improve compatibility.

After receiving the operation type and the operation instruction field, the network transaction system generates corresponding response information according to the operation type and specific content of the operation instruction field, for example, herein, generates a recharge order information of, for example, “You are going to recharge the mobile phone number 13811112222 for 100 Yuan, click here to confirm, or click here to cancel”, and returns the response information to the user account by using the transaction target account.

In Step 104, response information returned by the network transaction system is received and output to the communication session window, i.e., to a session window between the user account and the transaction target account. For example, the returned order information, for example, “You are going to recharge the mobile phone number 13811112222 for 100 Yuan, click here to confirm, or click here to cancel”, is output.

Then, if the response information is order information, the method according to the present disclosure may further include: receiving a confirmation instruction or a cancellation instruction input by the user in the communication session window, for example, it is determined that a confirmation instruction is received when a “click here to confirm” link in the order information is clicked, and it is determined that a cancellation instruction is received when a “click here to cancel” link in the order information is clicked; and if the confirmation instruction is received, information about order confirmation is sent to the network transaction system, and if the cancellation instruction is received, information about order cancellation is sent to the network transaction system.

After the information about order confirmation or the information about order cancellation is sent to the network transaction system, the network transaction system performs a network transaction process according to the received information about order confirmation, and returns transaction result information; and the method of the present disclosure further includes: receiving the transaction result information returned by the network transaction system, and outputting the transaction result information to the communication session window.

In step A, the text information initially input by the user in the communication session window may be simple, and may not include the text feature corresponding to the operation instruction field. For example, the user initially inputs “I want to recharge” in the communication session window. For this scenario, in another embodiment of the present invention, besides the foregoing step A to step D, after step D, the method further includes:

determining whether the text for each operation instruction field comprised by the operation type is determined, and if yes, sending the determined operation type and operation instruction field to the network transaction system; otherwise, returning, to the communication session window, prompt information for an operation instruction field for which the text is not determined, and after further receiving text information input by the user in the communication session window, going back to the previous step D.

For example, the user initially inputs “I want to recharge” in the communication session window, because text “recharge” having a text feature of the recharge operation type is included, it may determined that an operation type is the recharge operation type. However, the text information does not include text features of the phone number field and the money amount field, and therefore no text information is added to the phone number field and the money amount field. In this case, prompt information for the operation instruction field(s) (the phone number field and the money amount field herein) for which the text is not determined needs to be returned to the communication session window, for example, prompt information “what is the mobile phone number to be recharged? How much to recharge” may be returned. When the user sees the prompt information in the communication session window, the user further inputs “13811112222, 200 Kuai” according to the prompt. Then step D is repeated. Text “13811112222” that has the text feature of the phone number field and text “200” that has the text feature of the money amount field are found, “13811112222” is added to the phone number field, and “200” is added to the money amount field. Then, because text information is added to each operation instruction field of the recharge operation type, the determined recharge operation type and the operation instruction fields to which text is added are sent to the specified transaction target account of the network transaction system. The network transaction system then generates an order according to the information, and after the user confirms the order, may perform a subsequent network transaction process to complete the order.

In a specific application scenario of the present disclosure, the solution of the present disclosure is very suitable for network transactions of virtual commodities such as recharge, online game card recharge, and lottery purchase. Certainly, the present disclosure is also applicable to network transactions of physical products or services.

For example, in the present disclosure, it is also possible to pre-store a mobile phone sale operation type and a text feature of the mobile phone sale operation type, an operation instruction field included by the mobile phone sale operation type, and a text feature of the operation instruction field. For example, the text feature corresponding to the mobile phone sale operation type is: a text feature such as “buy . . . mobile phone” or “purchase . . . mobile phone” included in text information. The operation instruction fields included by the mobile phone sale operation type may include: fields such as mobile phone brand, model, color, and memory card capacity. A text feature corresponding to the mobile phone brand field may be a specific name of a mobile phone brand, such as Apple, Samsung, Huawei, or Mi; a text feature corresponding to the model field may be, for example, a character string within a specified length; a text feature corresponding to the color field may be: various colors, such as red, yellow, blue, green, black, and white; and a text feature corresponding to the memory card capacity field may be: a number that ends with a capacity unit such as “G”, and the like.

For example, if a user wants to buy a mobile phone, the user may input “I want to buy a mobile phone” in a communication session window between the user and a specified transaction account (for example, the account may be an account dedicated for selling electronic products). By using the foregoing method of the present disclosure, it may be learned through semantic analysis that a current operation type is the mobile phone sale operation type, and it is determined that the text information input currently does not include text features of fields such as mobile phone brand, model, color, and memory card capacity, and therefore prompt information “Please input a mobile phone brand, model, color, and memory card capacity” is returned to the communication session window. After the user sees the prompt information, the user inputs corresponding text for the fields in the window, for example, inputting “Apple, iphone5, white, 32 G”. In the present disclosure, semantic analysis is performed again on the information input by the user, text for each field is identified and added to corresponding fields and the fields are sent to the network transaction system. The network transaction system generates an order according to the information, and if the user confirms the order, performs subsequent transaction processes, for example, instructs the user to pay electronic money, and instructs a delivery center to deliver goods.

In addition to the foregoing operation types that can trigger an order directly, in the present disclosure, another operation type, a text feature of the another operation type, an operation instruction field of the another operation type, and a text feature of the operation instruction field may also be pre-stored. For example, a transaction record query operation type may be pre-stored, and the transaction record query operation type includes starting and ending time fields.

For example, a user inputs text information “I want to query for my transaction record” in a communication session window. It is determined through the foregoing semantic analysis that a current operation type is the transaction record query operation type, and then “Please input starting and ending time” is returned to the communication session window. The user then inputs “2012-12-23 to 2013-4-11” in the communication session window. By using the method of the present disclosure, semantic analysis is performed again, 2012-12-23 is filled in a starting time field, and 2013-4-11 is filled in an ending time field, and then the transaction record query operation type and the starting and ending time fields are sent to the network transaction system. The network transaction system generates corresponding transaction record information, and returns the transaction record information to the communication session window of the user as response information for display.

Corresponding to the foregoing method, the present disclosure further discloses a system for identifying and processing text operation instruction, which is used to execute the foregoing method. FIG. 2 is a schematic composition diagram of the system for identifying and processing text operation instruction according to the present disclosure. Referring to FIG. 2, the system for identifying and processing text operation instruction 200 includes a session module 201, an instruction analysis module 202, an instruction sending module 203 and a response module 204.

The session module 201 is configured to present a communication session window between a user and a network transaction system.

The instruction analysis module 202 is configured to receive text information input by the user in the communication session window, and perform text semantic analysis on the text information to determine an operation type and an operation instruction field.

The instruction sending module 203 is configured to send the operation type and the operation instruction field that are determined by the instruction analysis module to the network transaction system, where after receiving the information, the network transaction system performs related processing of network transaction, and may further perform related interaction with a payment system, and then the network transaction system returns a data processing result to the system 200 as response information.

The response module 204 is configured to receive the response information returned by the network transaction system, and output the response information to the communication session window.

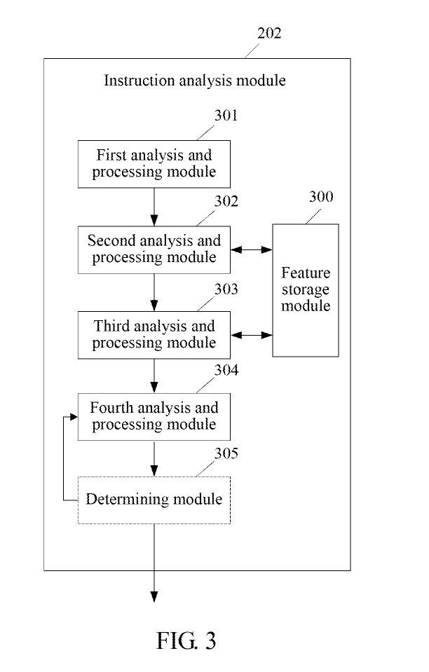

FIG. 3 is a specific schematic composition diagram of the instruction analysis module 202 according to an embodiment of the present invention. The instruction analysis module 202 includes:

a feature storage module 300, configured to store text features corresponding to operation types, operation instruction fields comprised by the operation types, and text features of the operation instruction fields;

a first analysis and processing module 301, configured to receive the text information input by the user in the communication session window;

a second analysis and processing module 302, configured to check whether the text information includes a text feature corresponding to a pre-stored operation type, and if the text information includes the text feature corresponding to a pre-stored operation type, determine the pre-stored operation type as the operation type corresponding to the text feature;

a third analysis and processing module 303, configured to read each operation instruction field included by the pre-stored operation type and a text feature of each operation instruction field; and

a fourth analysis and processing module 304, configured to check whether the text information comprises text having the text feature of the operation instruction field, and if yes, determine the text as the operation instruction field.

Further, in an embodiment, the processing system further includes:

a determining module 305, configured to determine whether the text for each operation instruction field comprised by the operation type is determined, and if yes, trigger the instruction sending module 203 to send the determined operation type and operation instruction field to the network transaction system; otherwise, return, to the communication session window, prompt information for an operation instruction field for which the text is not determined, and after text information input by the user in the communication session window is further received, re-trigger the fourth analysis and processing module 304 to perform processing.

In a preferred embodiment of the system of the present disclosure, the operation type specifically is a transaction operation type; the response module is specifically configured to: receive order confirmation information returned by the network transaction system, and return the order confirmation information to the communication session window; and the system for identifying and processing text operation instruction further includes an order confirmation module configured to: receive a confirmation instruction or a cancellation instruction input by the user in the communication session window; if a confirmation instruction is received, send information about order confirmation to the network transaction system; and if a cancellation instruction is received, send information about order cancellation to the network transaction system.

In a preferred embodiment of the system of the present disclosure, the response module is further configured to: receive transaction result information returned by the network transaction system, and output the transaction result information to the communication session window.

In the present disclosure, the system for identifying and processing text operation instruction of the present disclosure is provided in a specified communication tool program, for example, an instant communication tool program, or a social communication tool program, such as a WeChat program or a microblog program; the session module is specifically configured to: present, in the specified communication tool program, a communication session window between a user account and a specified transaction target account of the network transaction system; and there is a communication interface between the communication tool program and the network transaction system, and information exchange between the communication tool program and the network transaction system is performed through the communication interface. The system for identifying and processing text operation instruction may be provided in a front-end device, or may be provided at server end; or at least the session module in the system is provided in the front-end device, and other modules are provided at the server end.

In the present disclosure, the session module may be generally provided in a front-end device of a website system. The front-end device generally refers to an end that interacts with a user, and may be implemented by using a dedicated client, or may be implemented by a network browser accessing a server, i.e., a browser/server (B/S) structure may be used, or a client/server (C/S) structure may be used. However, in an age of rapid development of network information, a system architecture may be developed and changed further, and no matter which architecture is used, core ideas and core functional modules of the present disclosure are the same, and only locations of modules for executing specific functions are different.

In a typical application scenario, the session module may generally be provided in a front-end device of a website system. Correspondingly, the present disclosure further discloses a server, which coordinates and communicates with the front-end device and may execute the foregoing method. The front-end device may be a common communication client, has a session module, configured to present a communication session window between a user and a network transaction system, and may implement communication with a peer communication end. The server is configured to transmit and process information of the front-end device.

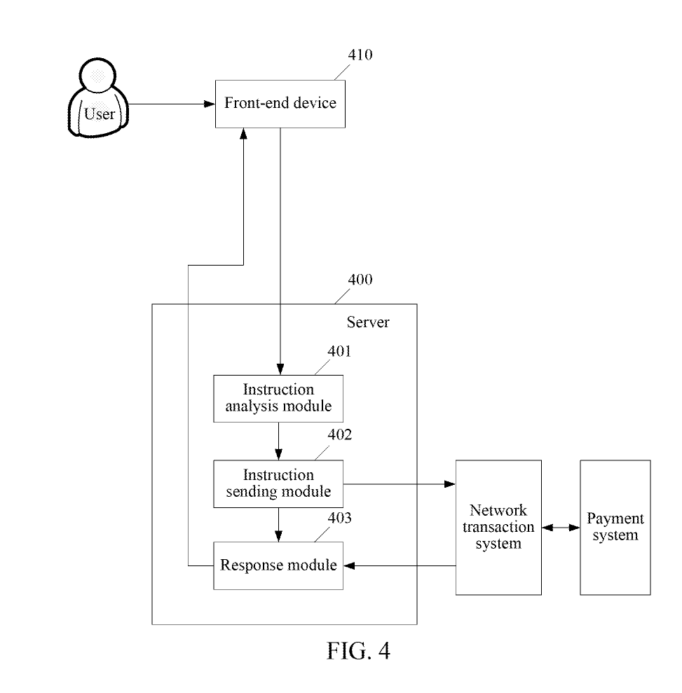

FIG. 4 is a schematic diagram of signal interaction and composition of the server and the front-end device according to the present disclosure. Referring to FIG. 4, the front-end device 410 is configured to provide a function of human-computer interaction with a user, and may specifically present a communication session window, upload content input by the user in the communication session window to the server, receive information returned by the server, and display the information in the communication session window.

The server 400 includes:

an instruction analysis module 401, configured to receive text information from the front-end device, and perform text semantic analysis on the text information to determine an operation type and an operation instruction field;

an instruction sending module 402, configured to send the operation type and the operation instruction field that are determined by the instruction analysis module 401 to a network transaction system; and

a response module 403, configured to receive response information returned by the network transaction system, and output the response information to a sender of the text information, i.e., the front-end device, where the front-end device then outputs the response information to the communication session window.

In a specific embodiment, the instruction analysis module specifically is the same as the instruction analysis module of FIG. 3, and specifically includes:

a feature storage module, configured to store text features corresponding to operation types, operation instruction fields comprised by the operation types, and text features of the operation instruction fields;

a first analysis and processing module, configured to receive the text information from the front-end device;

a second analysis and processing module, configured to check whether the text information includes a text feature corresponding to a pre-stored operation type, and if yes, determine the pre-stored operation type as the operation type corresponding to the text feature;

a third analysis and processing module, configured to read each operation instruction field included by the pre-stored operation type and a text feature of each operation instruction field; and

a fourth analysis and processing module, configured to check, according to the text feature of the operation instruction field, whether the text information includes text information having the text feature, and if the text information comprises text having the text feature of the operation instruction field, determine the text as the operation instruction field.

Further, in an embodiment, based on the foregoing embodiment, the server further includes: a determining module, configured to determine whether the text for each operation instruction field comprised by the operation type is determined, and if yes, trigger the instruction sending module to send the determined operation type and operation instruction field to the network transaction system; otherwise, return, to the sender of the text information, prompt information for an operation instruction field for which the text is not determined. The front-end device then outputs the prompt information to the communication session window; and after further receiving text information from the front-end device, the server re-triggers the fourth analysis and processing module to perform processing.

In a preferred embodiment of the server, the operation type specifically is a transaction operation type; the response module 403 is specifically configured to: receive order confirmation information returned by the network transaction system, and return the order confirmation information to the sender of the text information, i.e., the front-end device 410. The front-end device 410 then outputs the order confirmation information to the communication session window; and the server further includes an order confirmation module, configured to receive a confirmation instruction or a cancellation instruction, if a confirmation instruction is received, send information about order confirmation to the network transaction system, and if a cancellation instruction is received, send information about order cancellation to the network transaction system.

Further, in an embodiment, based on the foregoing embodiment, the response module 403 is further configured to: receive transaction result information returned by the network transaction system, and output the transaction result information to the sender of the confirmation instruction or cancellation instruction, i.e., the front-end device 410. The front-end device 410 then outputs the transaction result information to the communication session window.

Compared with the existing technology, in the present disclosure, if there is a demand for transaction when a user uses a communication tool, it is not necessary to open a new program or page to complete a network transaction; instead, text information used for the transaction demand is input directly in a communication session window of the communication tool, and text semantic analysis is automatically performed on the text information input by the user to determine an operation type and an operation instruction field, the determined operation type and operation instruction field are sent to a network transaction system, response information returned by the network transaction system is received and output to the communication session window, so as to complete the network transaction. Throughout the process, no new program or page is opened on a terminal, so that consumption of terminal resources is reduced; and the user does not need to perform complex human-computer interaction with a new program or page to fill in various transaction information, but directly inputs the text information. Therefore, the user can perform the network transaction conveniently, convenience and operation efficiency of the network transaction are improved, operation of the user is simple, and an operation time is correspondingly reduced.

The solutions of the present disclosure are especially applicable to a portable intelligent terminal having limited processing capability and screen size. When the user uses the portable intelligent terminal to perform a network transaction, by using the solutions of the present disclosure, the foregoing beneficial effects of improving convenience and operation efficiency of the network transaction and reducing consumption of terminal resources are more obvious.

It should be noted that, not all steps and modules in the foregoing procedures and structural diagrams are necessary, some steps or modules may be omitted according to actual needs. An execution sequence of the steps is not fixed, and may be adjusted according to needs. Division of the modules is merely functional division for ease of description. In actual implementation, one module may be implemented separately by multiple modules, and functions of multiple modules may also be implemented by one same module. The modules may be located in a same device as software program codes stored in a memory, or as logic gates fused in a FPGA or an ASIC, or a combination of software and hardware, and may also be located in different devices. In addition, “first” and “second” in the foregoing descriptions are only used to help distinguish two objects having a same meaning, and do not indicate a substantial difference.

Hardware modules in the embodiments may be implemented in a mechanic manner or an electronic manner. For example, a hardware module may include a specifically designed permanent circuit or logical device (for example, a dedicated processor, such as an FPGA or an ASIC) for completing a specific operation. The hardware module may also include a programmable logical device or circuit (for example, including a general processor or another programmable processor) configured temporarily by software and configured to execute a specific operation. Whether the hardware module is specifically implemented in a mechanic manner, by using a dedicated permanent circuit, or by using a temporarily-configured circuit (for example, configured by software) may be determined according to considerations of costs and time.

The present disclosure further provides a machine readable storage medium, which stores an instruction that are used to make a machine to execute the method described in this specification. Specifically, a system or an apparatus that is equipped with a storage medium may be provided. The storage medium stores software program code that implements functions of any embodiment in the foregoing embodiments, and a computer (a CPU or an MPU) of the system or the apparatus is enabled to read and execute the program code stored in the storage medium. In addition, a program code based instruction may also be used to enable an operating system or the like running in the computer to complete some or all actual operations. The program code read from the storage medium may also be written to a memory that is disposed in an extension board inserted in the computer, or may be written to a memory that is disposed in an extension unit connected to the computer, and then a CPU or the like that is installed on the extension board or extension unit may be enabled to execute some or all actual operations based on the instruction of the program code, so as to implement the functions of any embodiment in the foregoing embodiments.

Embodiments of the storage medium for providing the program code may include a floppy disk, a hard disk, a magneto-optical disk, an optical memory (such as a CD-ROM, a CD-R, a CD-RW, a DVD-ROM, a DVD-RAM, a DVD-RW, and a DVD+RW), a magnetic tape, a non-volatile storage card, and a ROM. Optionally, the program code may be downloaded form a server computer through a communications network.

In conclusion, the scope of the claims should not be limited to the implementation manners in the foregoing described examples, but instead the specification should be considered as a whole and interpreted in a broadest manner.

What is claimed is:

1. A method for identifying and processing text operation instruction on a communication terminal, comprising the communication terminal performing:
presenting a communication session window between a user and a network transaction system;
receiving text information input by the user in the communication session window, and performing text semantic analysis on the text information to determine an operation type and an operation instruction field;
sending the determined operation type and operation instruction field to the network transaction system; and
receiving response information returned by the network transaction system, and outputting the response information to the communication session window.

2. The method according to claim 1, wherein the receiving of the text information input by the user in the communication session window, and the performing of the text semantic analysis on the text information to determine the operation type and the operation instruction field, comprises the communication terminal, performing:
receiving the text information input by the user in the communication session window;
checking whether the text information comprises a text feature corresponding to a pre-stored operation type, and if the text information comprises the text feature corresponding to the pre-stored operation type, determining the pre-stored operation type as the operation type corresponding to the text feature;
reading each operation instruction field comprised by the pre-stored operation type and a text feature of each operation instruction field; and
checking whether the text information comprises text having the text feature of the operation instruction field, and if yes, determining that the text being the operation instruction field.

3. The method according to claim 2, wherein after checking whether the text information comprises text having the text feature of the operation instruction field, the method further comprises the communication terminal, performing:
determining whether the text for each operation instruction field comprised by the operation type is determined, and if yes, sending the determined operation type and operation instruction field to the network transaction system; otherwise, returning, to the communication session window, prompt information for an operation instruction field for which the text is not determined, and after further receiving text information input by the user in the communication session window, checking whether the text information comprises text having the text feature of the operation instruction field.

4. The method according to claim 1, wherein
the operation type is a transaction operation type;
the receiving of the response information returned by the network transaction system comprises receiving order confirmation information returned by the network transaction system; and
after the order confirmation information is returned to the communication session window, the method further comprises the communication terminal performing
receiving a confirmation instruction or a cancellation instruction input by the user in the communication session window, and if a confirmation instruction is received, sending information about order confirmation to the network transaction system, or if a cancellation instruction is received, sending information about order cancellation to the network transaction system.

5. The method according to claim 4, wherein after the sending of the information about order confirmation to the network transaction system, the method further comprises the communication terminal performing:
receiving transaction result information returned by the network transaction system, and outputting the transaction result information to the communication session window.

6. The method according to claim 1, wherein
the presenting of the communication session window between the user and the network transaction system comprises the communication terminal performing:
presenting, in a specified communication tool program, the communication session window between a user account and a specified transaction target account of the network transaction system; wherein there is a communication interface between the communication tool program and the network transaction system, and wherein information exchange between the communication tool and the network transaction system is performed through the communication interface.

7. A system for identifying and processing text operation instruction, comprising:
a communication terminal having one or more processors, executing program codes stored in a memory, which configure the communication terminal to;
present a communication session window between a user and a network transaction system;
receive text information input by the user in the communication session window, and perform text semantic analysis on the text information to determine an operation type and an operation instruction field;
send the operation type and the operation instruction field that are determined by the instruction analysis module to the network transaction system; and
receive response information returned by the network transaction system, and output the response information to the communication session window.

8. The system according to claim 7, wherein the communication terminal is configured to:
store text features corresponding to operation types, operation instruction fields comprised by the operation types, and text features of the operation instruction fields;
receive the text information input by the user in the communication session window;
check whether the text information comprises a text feature corresponding to a pre-stored operation type, and if the text information comprises the text feature corresponding to a pre-stored operation type, determine the pre-stored operation type as the operation type corresponding to the text feature;
read each operation instruction field comprised by the pre-stored operation type and a text feature of each operation instruction field; and
check whether the text information comprises text having the text feature of the operation instruction field, and if yes, determine that the text being the operation instruction field.

9. The system according to claim 8, wherein the communication terminal is configured to:
determine whether the text for each operation instruction field comprised by the operation type is determined, and if yes, send the determined operation type and operation instruction field to the network transaction system; otherwise, return, to the communication session window, prompt information for an operation instruction field for which the text is not determined, and after text information input by the user in the communication session window is further received, re-trigger to perform processing.

10. The system according to claim 7, wherein
the operation type is a transaction operation type;
the communication terminal is further configured to: receive order confirmation information returned by the network transaction system, and return the order confirmation information to the communication session window; and
receive a confirmation instruction or a cancellation instruction input by the user in the communication session window;
if a confirmation instruction is received, send information about order confirmation to the network transaction system; and
if a cancellation instruction is received, send information about order cancellation to the network transaction system.

11. The system according to claim 10, wherein the communication terminal is further configured to: receive transaction result information returned by the network transaction system, and output the transaction result information to the communication session window.

12. The system according to claim 10, wherein
the communication terminal is provided in a specified communication tool program;
the communication terminal is further configured to: present, in the specified communication tool program, the communication session window between a user account and a specified transaction target account of the network transaction system; and
there is a communication interface between the communication tool program and the network transaction system, and information exchange between the communication tool program and the network transaction system is performed through the communication interface.

13. A server, comprising:
one or more processors executing program codes stored in a memory, which configure the server to:
receive text information, and perform text semantic analysis on the text information to determine an operation type and an operation instruction field;
send the operation type and the operation instruction field to a network transaction system; and
receive response information returned by the network transaction system, and output the response information to a sender of the text information.

14. The server according to claim 13, wherein the server is configured to:
store text features corresponding to operation types, operation instruction fields comprised by the operation types, and text features of the operation instruction fields;
receive the text information;
check whether the text information comprises a text feature corresponding to a pre-stored operation type, and if the text information comprises the text feature corresponding to a pre-stored operation type, determine the pre-stored operation type as the operation type corresponding to the text feature;
read each operation instruction field comprised by the pre-stored operation type and a text feature of each operation instruction field; and
check whether the text information comprises text having the text feature of the operation instruction field, and if yes, deter mine the text as the operation instruction field.

15. The server according to claim 14, wherein the server is further configured to:
determine whether the text for each operation instruction field comprised by the operation type is determined, and if yes, trigger the instruction sending module to send the determined operation type and operation instruction field to the network transaction system; otherwise, return, to the sender of the text information, prompt information for an operation instruction field for which the text is not determined, and after text information is further received, re-trigger the fourth analysis and processing module to perform processing.

16. The server according to claim 13, wherein
the operation type is a transaction operation type;
the server is further configured to:
receive order confirmation information returned by the network transaction system, and return the order confirmation information to the sender of the text information; and
receive a confirmation instruction or a cancellation instruction; if a confirmation instruction is received, send information about order confirmation to the network transaction system; and if a cancellation instruction is received, send information about order cancellation to the network transaction system.

17. The server according to claim 16, wherein the server is further configured to: receive transaction result information returned by the network transaction system, and output the transaction result information to the sender of the confirmation instruction or cancellation instruction.
